(19) United States
(12) Patent Application Publication
(10) Pub. No.: US 2011/0087915 A1
(43) Pub. Date: Apr. 14, 2011

(54) HYBRID RELIABLE STREAMING PROTOCOL FOR PEER-TO-PEER MULTICASTING

(76) Inventors: Meng ZHANG, Palo Alto, CA (US); Pierpaolo Baccichet, Palo Alto, CA (US)

(21) Appl. No.: 12/577,025

(22) Filed: Oct. 9, 2009

(51) Int. Cl. G06F 11/16; H04L 12/56; G06F 15/16

(52) U.S. Cl. 714/2; 370/390; 709/219; 709/239; 714/E11.054

(57) ABSTRACT

Peer-to-peer multicasting of streaming data in a node in a peer-to-peer computer environment. A transmission of packets is received at the node, wherein the packets are data packets pushed from a parent node and comprises data of a sub stream of the streaming data. A buffer map of the node is created at the node, wherein the buffer map lists the packets that have been received and an available bandwidth of the node. The node is connected with at least one neighboring node. The buffer map of the node is exchanged with a buffer map of the at least one neighboring node. Provided a determination is made that at least one packet in the sub stream of the streaming data was not received at the node, the at least one packet is pulled from the at least one neighboring.

### BACKGROUND

Networked computer systems have the ability to stream data from one computer system to another using a network such as the Internet. Live media streaming to a large population of users has been achieved using a pool of server computer systems that relay data directly to each user. Such an approach has drawbacks. For example, an upper limit exists as to how many users each server computer system can directly relay data to. Additionally, such a technique is scalable only by adding costly server computer systems to the pool of server computer systems and may not be scalable during the live media streaming.

### BRIEF DESCRIPTION OF THE DRAWINGS

FIG. 1 illustrates a block diagram of an example peer-to-peer computer environment in accordance with embodiments of the present technology.

FIG. 2 illustrates a block diagram of how data packets may be organized in a node in a peer-to-peer computer environment comprising multiple components in accordance with embodiments of the present technology.

FIG. 3 illustrates a flowchart of an example method for peer-to-peer multicasting of streaming data in a node in a peer-to-peer computer environment in accordance with embodiments of the present technology.

FIG. 4 illustrates a diagram of an example computer system upon which embodiments of the present technology may be implemented.

The drawings referred to in this description of embodiments should be understood as not being drawn to scale except if specifically noted.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

Unless specifically stated otherwise as apparent from the following discussions, it is appreciated that throughout the present description of embodiments, discussions utilizing terms such as “receiving,” “creating,” “connecting,” “exchanging,” “pulling,” “pushing,” “joining,” “determining,” “relaying,” “re-pulling,” “compressing,” “controlling,” “estimating,” or the like, refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. Embodiments of the present technology are also well suited to the use of other computer systems such as, for example, optical and mechanical computers.

### Overview of Discussion

Embodiments of the present technology are for hybrid reliable streaming protocol for peer-to-peer multicasting of streaming data in a node in a peer-to-peer computer environment. For example, a node may be one of several nodes and may be personal computer system used for live media streaming. Each node has a limited amount of resources that may be used for multicasting of streaming data in a peer-to-peer computer environment.

In one embodiment, a source node in a peer-to-peer computer environment broadcast streaming data over the peer-to-peer computer environment. The streaming data may be a live video casting stream. In one embodiment, the data stream is broken into several sub streams and each sub stream is broadcasted over a tree. A tree is a widely-used data structure that emulates a hierarchical tree structure with a set of linked nodes, each node has a set of zero or more children nodes, and at most one parent node (by convention, trees grow down, not up as they do in nature). Each node desiring to receive the data stream must connect to each of the trees corresponding to each of the sub streams. This may be accomplished by a node contacting a tracker system in the peer-to-peer computer environment and obtaining a list of previously connected nodes suitable to act as parent in the distribution trees. The node may then select a parent node for each tree. A tracker system here is used to identify all nodes in the same cluster.

In one embodiment, each parent node in a tree pushes the data sub stream to the node in the form of data packets. In doing so, a data packet may be lost, missing, or is delayed before it is received by the node. To overcome this issue, in one embodiment, the node will connect with neighboring nodes that are also receiving the data sub streams in the same or different trees from the node. The node and neighboring nodes will create buffer maps that list packets received. The buffer map of the node is exchanged with the buffer maps of the neighboring nodes and contains information about which packets are available at any given time in the sending node.

After the exchange has taken place, the node may pull a missing, lost or delayed packet from a neighboring node that has received the missing, lost or delayed packet. The node may also allow neighboring nodes to pull packets that the neighboring nodes are missing from the node. In this manner, all nodes in the peer-to-peer computer environment are able to receive the data packets of the sub streams during a live media streaming broadcast.

Benefits of the present technology include using a hybrid reliable technique that encompasses the benefits of both pulling and pushing streaming data. Additionally, the present technology is well suited for operation in a peer-to-peer computer environment where an unlimited number of nodes may join or exit the peer-to-peer computer environment during a live media streaming broadcast. Thus, the present technology may be implemented without the need of costly infrastructure and is scalable during a live media streaming broadcast.

The following discussion will demonstrate various hardware, software, and firmware components that are used with and in computer systems for peer-to-peer multicasting of streaming data in a node in a peer-to-peer computer environment using various embodiments of the present technology. Furthermore, the systems and methods may include some, all, or none of the hardware, software, and firmware components discussed below.

The following discussion will center on computer systems or nodes operating in a peer-to-peer computer environment. It should be appreciated that a peer-to-peer computer environment is well known in the art and is also known as a peer-to-peer network and is often abbreviated as P2P. It should be understood that a peer-to-peer computer environment may comprise multiple computer systems, and may include routers and switches, of varying types that communicate with each other using designated protocols. In one embodiment, a peer-to-peer computer environment is a distributed network architecture that is composed of participants that make a portion of their resources (such as processing power, disk storage, and network bandwidth) available directly to their peers without intermediary network hosts or servers.

### Embodiments of a System for Peer-to-Peer Multicasting of Streaming Data in a Node in a Peer-to-Peer Computer Environment

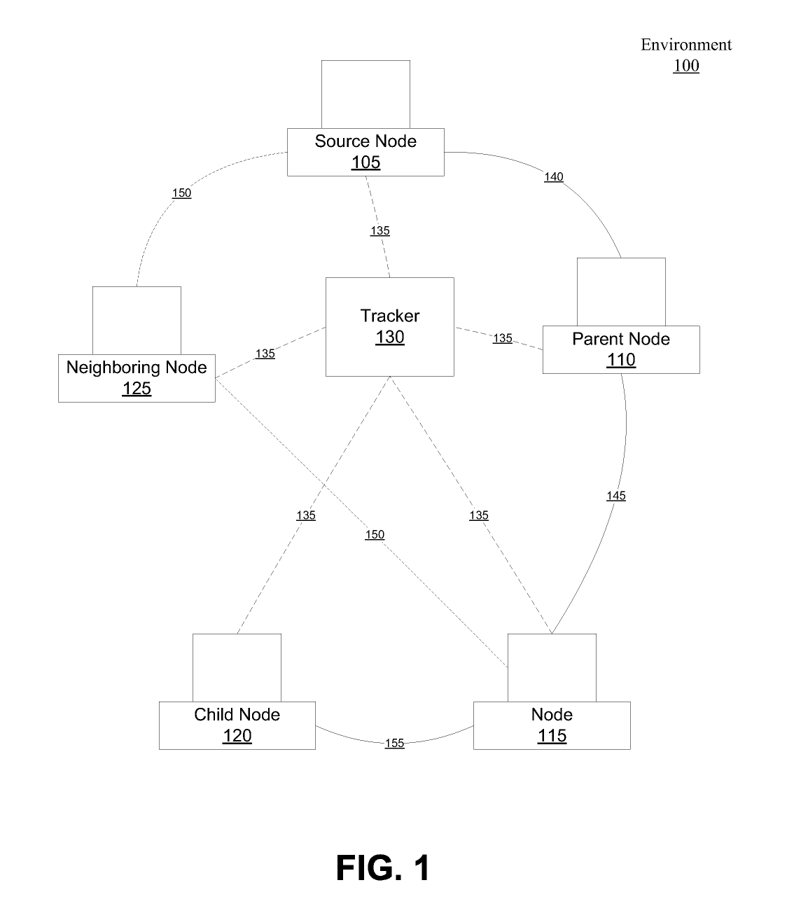

With reference now to FIG. 1, a block diagram of an example peer-to-peer computer environment for use in peer-to-peer multicasting of streaming data in a node in a peer-to-peer computer environment. Environment 100 includes source node 105, parent node 110, node 115, child node 120, neighboring node 125 and tracker 130. Environment 100 comprises components that may or may not be used with different embodiments of the present technology and should not be construed to limit the present technology.

In one embodiment, environment 100 includes source node 105, parent node 110, node 115, child node 120 and neighboring node 125. These nodes may be computer systems including server computer systems, personal computer systems, virtual computer systems or other systems that are capable of receiving and sending streaming data over a network. These nodes may have a limited number of resources for carrying out receiving and sending streaming data over a network. Such resources may include central processing unit (CPU) usage, memory usage, quality of service (QOS), bandwidth for both upload and download, storage capacity, etc. In one embodiment, the streaming data is video casting in a low delay environment.

In one embodiment, source node 105 transmits streaming data over environment 100 by breaking the data stream into any number of sub streams of data to be sent over corresponding trees in a peer-to-peer computer environment. In one embodiment, each sub stream of data in transmitted over one corresponding distribution tree. In one embodiment, the streaming data is divided into eight sub streams. In one embodiment, the data of the sub streams is sent to the child nodes of source node 105 in the form of data packets. It should be appreciated that source node 105 may have a different child node for each tree corresponding to each sub stream of data. It should also be appreciated that in the tree architecture, a child node is defined as a node that is receiving a push based transmission from a parent node and a parent node is defined a node that is pushing a transmission to a child node. Therefore a source node may be pushing several sub streams of data to several different children node simultaneously.

In one embodiment, parent node 110 is a child node of source node 105 and is receiving a push based transmission of one sub stream of data from source node 105 as is demonstrated by communication line 140. In one embodiment, both parent node 110 and neighboring node 125 are both children node of source node 105 and receive the same sub stream of data. In one embodiment, parent node 110 then relays or re-transmits the sub stream of data to node 115 in a pushed based transmission. Communication line 145 demonstrates node 115 attaching to parent node 110 and receiving a pushed based transmission. Node 115 receives the push based transmission of the sub stream of data and may relay or re-transmit the sub stream of data to child node 120. In this manner, source node 105, parent node 110, node 115, child node 120 and neighboring node 125 form a tree based architecture for one sub stream of data.

In one embodiment, a node desiring to join a tree and receive a push based transmission of a sub stream of data must obtain a parent node to receive the push based transmission from. In one embodiment, this is accomplished by a node first obtaining a list of candidate parent node from tracker 130 as is demonstrated by communication lines 135. It should be appreciated that tracker 130 may be an agent that is running on a node in the peer-to-peer computer environment or may be an independent node in the peer-to-peer computer environment. In one embodiment, tracker 130 is part of or coupled with source node 105. In one embodiment, the peer-to-peer computer environment comprises more than one tracker. It should also be appreciated that tracker 130 may be hardware, firmware, software or any combination thereof.

For example, node 115 may desire to join environment 100 and receive a pushed based transmission of the sub stream of data. To do so, node 115 will first contact tracker 115 and obtain a list of candidate parent nodes. In one embodiment, the list of candidate parent nodes includes nodes that are already part of the tree corresponding to the sub stream of data. In this example, the list may include source node 105, neighboring node 125 and parent node 110. In one embodiment, node 115 then contacts each of the nodes on the list of candidate parent nodes and discovers the available resources of each candidate parent. Such resources may include the availability of bandwidth and other computer related resources. In one embodiment, node 115 then selects a parent node based on the available resources of candidate parent nodes. In this example, node 115 selects parent node 110 as its parent node for the sub stream of data.

In one embodiment, child node 120 selects node 115 after node 115 has joined the tree to be its parent node for the sub stream of data using the same process described above. In one embodiment, node 115 selects parent node 110 as a parent node and receives a push based transmission of the sub stream of data from parent node 110 for a time period after which parent node 110 stops transmitting. This is demonstrated using communication line 155. In one embodiment, node 115 may then repeat the process of contacting tracker 130 and selecting a new parent node to receive the pushed based transmission from. It should be appreciated that a parent node may stop transmitting for any number of reasons including, but not limited to, suffering an error, quitting the peer-to-peer computer environment, and a failure to receive the transmission from its parent.

In one embodiment, a candidate parent node may deny a selection to be a parent node based on the available resources of the parent. Such a determination may be made by a congestion control component. In one embodiment, each node in the peer-to-peer computer environment has a congestion control component which monitors the available resources of the node and makes determination regarding the number of child nodes that may be allowed to connect with the node. In one embodiment, node 115 may have available bandwidth for several child nodes to connect with node 115; however, node 115 may limit the number of child nodes allowed to connect with node 115 therefore reserving a portion of node 115′s available bandwidth. In one embodiment, node 115 reserves a portion of available uplink bandwidth for a neighboring node to pull a packet of the received sub stream of data from node 115.

In one embodiment, a node in the tree may not receive one or more of the packets in the sub stream of data. For example, node 115, after selecting parent node 110 as a parent node, may receive data packets of the sub stream of data but may be missing one or more of the packets. It should be appreciated that data packets not received from a parent node in a push based transmission may be missing, lost, delayed, or not received for any other reason. To obtain the missing packet node 115 may employ the use of a neighboring node.

In one embodiment, node 115 connects with one or more neighboring nodes. For example, node 115 may connect with neighboring node 125. It should be appreciated that a neighboring node may or may not be in the same tree as the node it is connecting with and is not necessarily a parent node or child node as well as a neighboring node. It should be appreciated that a neighboring node may be discovered by the node contacting a tracker, receiving probing packets from other nodes, when other nodes would like to attach the nodes for a tree, or other techniques. It should also be appreciated that neighboring nodes are not required to be physically proximate to each other.

In one embodiment, node 115 creates a buffer map to be exchanged with neighboring nodes. In one embodiment, the buffer map contains a list of packets received and the available resources of node 115 including available bandwidth. In one embodiment, neighboring node 125 creates a similar buffer map with information pertaining to neighboring node 125. In one embodiment, node 115 and neighboring node 125 exchange buffer maps with each other as is demonstrated by communication line 150. In one embodiment, an exchange of buffer maps with neighboring nodes takes place on a periodic basis. In this manner a node is aware of the packets that have been received by neighboring nodes and the available resources of neighboring nodes. In one embodiment, neighboring nodes exchange buffer maps every 100 milliseconds. In one embodiment, neighboring nodes exchange buffer maps every 250 milliseconds.

In one embodiment, the buffer map comprises a bit vector where every bit set to 1 corresponds to a packet in the buffer and every bit set to 0 corresponds to a packet that is missing in the current buffer. In one embodiment, the buffer map is compressed before it is exchanged with a neighboring node. For example, a buffer map using bit vectors may have a long string of consecutive sequence number that all have a bit value of 1. This data can be compressed utilizing a run-length entropy coder to reduce redundancy. Thus a buffer map may be compressed to less than ten percent of its original size.

In one embodiment, node 115 discovers, connects with, maintains contact with, and exchanges buffer map with neighboring node 125 using a network protocol. In one embodiment, neighboring nodes use a type of peer-to-peer gossip protocol to communicate.

In one embodiment, node 115 maintains a specified number of neighboring nodes. In one embodiment, node 115 maintains 15 neighboring nodes. If a neighboring node is lost for any reason, node 115 may connect with a new neighboring node to maintain the specified number. In so doing, node 115 may prevent connection closure effect.

In one embodiment, node 115 identifies that it is missing a data packet from parent node 110 in the pushed based transmission of the sub stream of data. Node 115 may then discover neighboring node 125 has received the missing data packet. In one embodiment, such a discovery is made employing the buffer maps that were received during the exchange with neighboring node 125. In one embodiment, node 115 will send a pull based request to neighboring node 125 to transmit the missing data packet to node 115. In one embodiment, the pull based request for the missing data packet is repeated if the missing data packet is not received by node 115 after a specified time period or timeout threshold. In one embodiment, node 115 repeats the pull based request to different neighboring nodes after a specified time period has passed and node 115 did not receive the missing data packet from neighboring node 125. Such communications may take place over communication line 150.

In one embodiment, node 115 receives the missing data packet from neighboring node 125 and then transmits the missing data packet in a pushed based transmission to child node 120 and any other child node of node 115. Therefore, the missing data packet will be pushed down through the corresponding tree. In one embodiment, node 115 will successfully pull the missing data packet from neighboring node 125 and then later have the missing data packet pushed to it by parent node 110. In this case node 115 has a duplicate of the missing data packet. In one embodiment, node 115 will only push the missing data packet to child node 125 once and therefore avoid transmitting duplicate packets.

In one embodiment, node 115 measures the round trip time it takes to communicate with neighboring node 125 and other neighboring nodes. Such a measurement may be taken when node 115 exchanges buffer maps with its neighboring nodes. In one embodiment, node 115 will select a neighboring node with the shortest round trip time to pull the missing data packet from. In one embodiment, node 115 employs the measured round trip time for a neighboring node as the timeout threshold in which to re-send a pull based request for the missing data packet if the request was sent the missing data packet was not yet received.

In one embodiment, node 115 and any other node may maintain a delay threshold for each tree corresponding to a sub stream of data. In one embodiment, when a packet is not received within the delay threshold, then node 115 will pull the packet from a neighboring node. In one embodiment, the delay threshold is computed using an estimation of how long it takes a packet to transmit from the source to every destination in the tree. This estimation may be performed by marking each packet as either pulled or pushed. Once a pushed packet is completely transmitted throughout the tree, it is used to estimate how long it takes to push one packet through. In one embodiment, this estimate is used as the delay threshold that is used to make decision of when to pull a packet and when to wait for a packet to be pushed at a given node. In one embodiment, the delay threshold is adaptive for each packet that is transmitted through the tree.

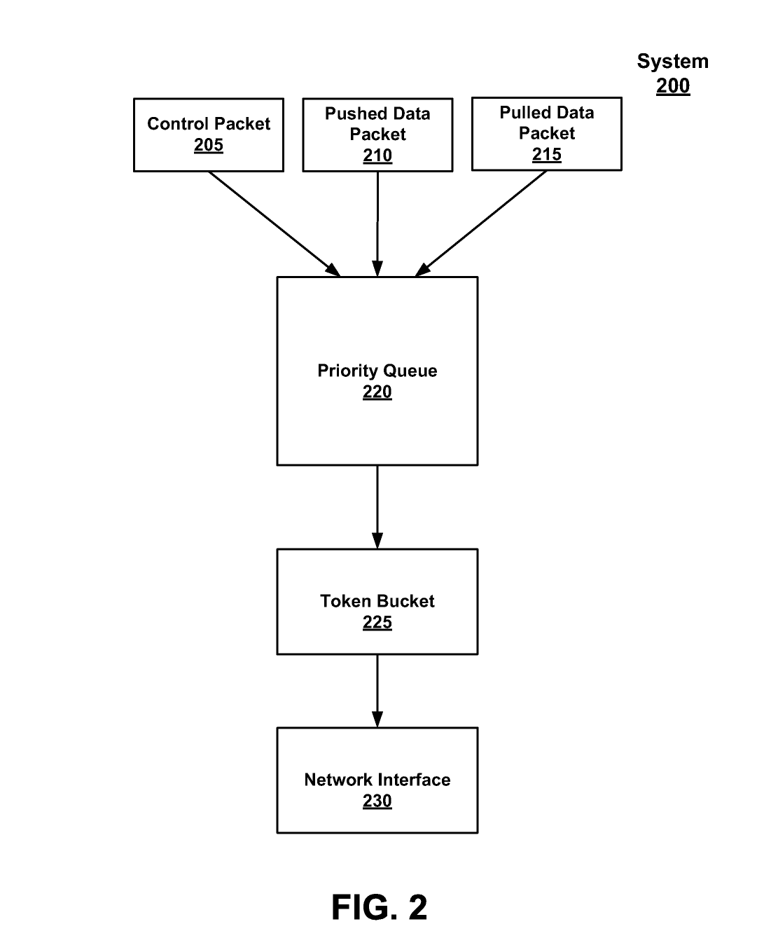

With reference now to FIG. 2, a block diagram of an example organization of how outgoing packets are organized in a node in a peer-to-peer computer environment for use in peer-to-peer multicasting of streaming data. System 200 includes control packet 205, pushed data packet 210, pulled data packet 215, priority queue 220, token bucket 225 and network interface 230. System 200 comprises components that may or may not be used with different embodiments of the present technology and should not be construed to limit the present technology.

In one embodiment, the node orders packets for outgoing transmission in a priority queue. In one embodiment, control packet 205 is given priority over outgoing pushed data packet 210 and outgoing pushed data packet 210 is given priority over outgoing pulled data packet 215. It should be appreciated that a control packet can be any packet that is not a data packet such as a buffer map packet, a data packet request packet, a tree joining request packet, a tree attach request packet, etc. In one embodiment, a P2P protocol is used that employs 36 different types of control packets. In one embodiment, this prioritization results in only residual uplink bandwidth being used for outgoing pulled data packets.

In one embodiment, the outgoing rate of packets is controlled by token bucket 225. In one embodiment, token bucket 225 controls the outgoing rate with a bandwidth limitation suggested by a congestion control component. In one embodiment, once the tokens are fully utilized, the packets will be queued and sorted by priority. In one embodiment, when the queue size exceeds a predetermined threshold, the outgoing pulled packets will be dropped. In one embodiment, when the queue is congested, outgoing pulled packets are reduced. In one embodiment, when a packet is going to send out, the packet will consume tokens in terms of the size of the packet, only if there are enough tokens in the bucket will the packet be sent out. Otherwise, the packet will be held in the queue.

### Operation

More generally, in embodiments in accordance with the present invention are utilized for peer-to-peer multicasting of streaming data in a node in a peer-to-peer computer environment.

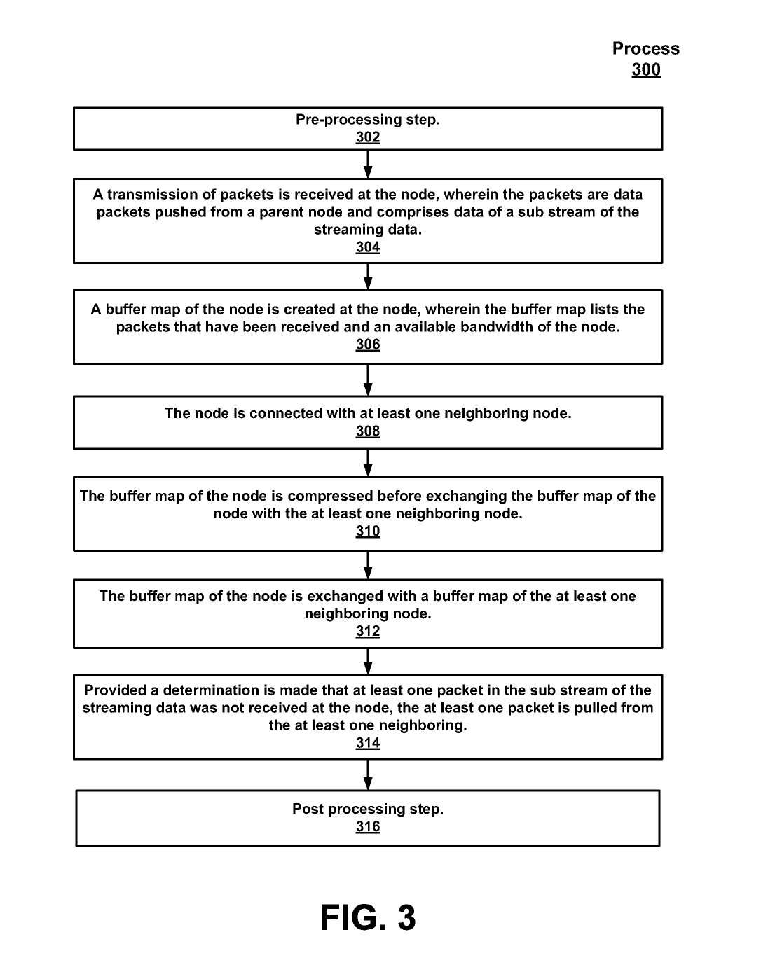

FIG. 3 is a flowchart illustrating process 300 for peer-to-peer multicasting of streaming data in a node in a peer-to-peer computer environment, in accordance with one embodiment of the present invention. In one embodiment, process 300 is a computer implemented method that is carried out by processors and electrical components under the control of computer usable and computer executable instructions. The computer usable and computer executable instructions reside, for example, in data storage features such as computer usable volatile and non-volatile memory. However, the computer usable and computer executable instructions may reside in any type of computer usable storage medium. In one embodiment, the methods may reside in a computer usable storage medium having instructions embodied therein that when executed cause a computer system to perform the method.

In one embodiment, pre-processing step 302 comprises the node joining a tree disseminating the sub stream of the streaming data by contacting a tracker in the peer-to-peer computer environment to obtain a list of candidates for parent nodes, wherein the parent nodes are connected to the tree. In one embodiment, pre-processing step 302 comprises contacting the candidate parent nodes to discover available resources of the candidate parent nodes. In one embodiment, pre-processing step 302 comprises selecting a parent node to connect with the node in the tree from the list of candidates, wherein the selecting is based on the available resources of the candidate parent nodes.

At 304, a transmission of packets is received at the node, wherein the packets are data packets pushed from a parent node and comprises data of a sub stream of the streaming data. In one embodiment, the node is node 115 and the parent node is parent node 110 of FIG. 1.

At 306, a buffer map of the node is created at the node, wherein the buffer map lists the packets that have been received and an available bandwidth of the node. In one embodiment, the buffer map has all the features of the buffer maps described above.

At 308, the node is connected with at least one neighboring node. In one embodiment, the node is node 115 and the at least one neighboring node is neighboring node 125 of FIG. 1.

At 310, the buffer map of the node is compressed before exchanging the buffer map of the node with the at least one neighboring node. In one embodiment, the compression is accomplished using the techniques described above.

At 312, the buffer map of the node is exchanged with a buffer map of the at least one neighboring node. In one embodiment, the node is node 115 and the at least one neighboring node is neighboring node 125 of FIG. 1 and the exchange takes place as described above.

At 314, provided a determination is made that at least one packet in the sub stream of the streaming data was not received at the node, the at least one packet is pulled from the at least one neighboring. In one embodiment, the node is node 115 and the at least one neighboring node is neighboring node 125 of FIG. 1.

In one embodiment, post processing step 316 comprises determining the node is no longer receiving the transmission of the packets from the parent node. In one embodiment, post processing step 316 comprises connecting the node with the tracker to select a new parent node. In one embodiment, the node is node 115, the tracker is tracker 130 and the parent node is parent node 110 of FIG. 1.

In one embodiment, post processing step 316 comprises connecting the node to at least one child node. In one embodiment, post processing step 316 comprises relaying the packets pushed from the parent node and the at least one packet pulled from the at least one neighboring node to the at least one child node. In one embodiment, the node is node 115 and the child node is child node 120 of FIG. 1.

In one embodiment, post processing step 316 comprises reserving a portion of uplink bandwidth of the node for the at least one neighboring nodes to pull the packets from the node. In one embodiment, the node is node 115 and the at least one neighboring node is neighboring node 125 of FIG. 1.

In one embodiment, post processing step 316 comprises connecting the node with a plurality of neighboring node. In one embodiment, post processing step 316 comprises determining a round trip time taken to communicate with each of the plurality of neighboring nodes. In one embodiment, post processing step 316 comprises selecting a neighboring node with a smallest round trip time for the pulling the at least one packet. In one embodiment, the node is node 115 and one of the neighboring nodes is neighboring node 125 of FIG. 1.

In one embodiment, post processing step 316 comprises re-pulling the at least one packet from the at least one neighboring node after a timeout threshold has expired and the at least one packet was not received after the pulling the at least one packet from the at least one neighboring node. In one embodiment, the node is node 115 and the at least one neighboring node is neighboring node 125 of FIG. 1.

In one embodiment, post processing step 316 comprises ordering control packets, pushed data packets and pulled data packets in a priority queue at the node. In one embodiment, post processing step 316 comprises controlling the out going rate of the control packets, the pushed data packets and the pulled data packets from the node with a token bucket at the node. In one embodiment, post processing step 316 comprises provided that the out going rate exceed a threshold, dropping the pulled data packets from the priority queue in the node. In one embodiment, the node is node 115 of FIG. 1 and the priority queue is priority queue 220 and the token bucket is token bucket 225 of FIG. 2.

In one embodiment, post processing step 316 comprises estimating a delay threshold for a packet to be received at the node from the parent node, wherein the delay threshold is estimated based on how long it takes a previous data packet to be pushed through a tree. In one embodiment, post processing step 316 comprises making a determination to pull a missing packet from the at least one neighboring node based on the delay threshold. In one embodiment, the node is node 115, the parent node is parent node 110 and the at least one neighboring node is neighboring node 125 of FIG. 1.

### Example Computer System Environment

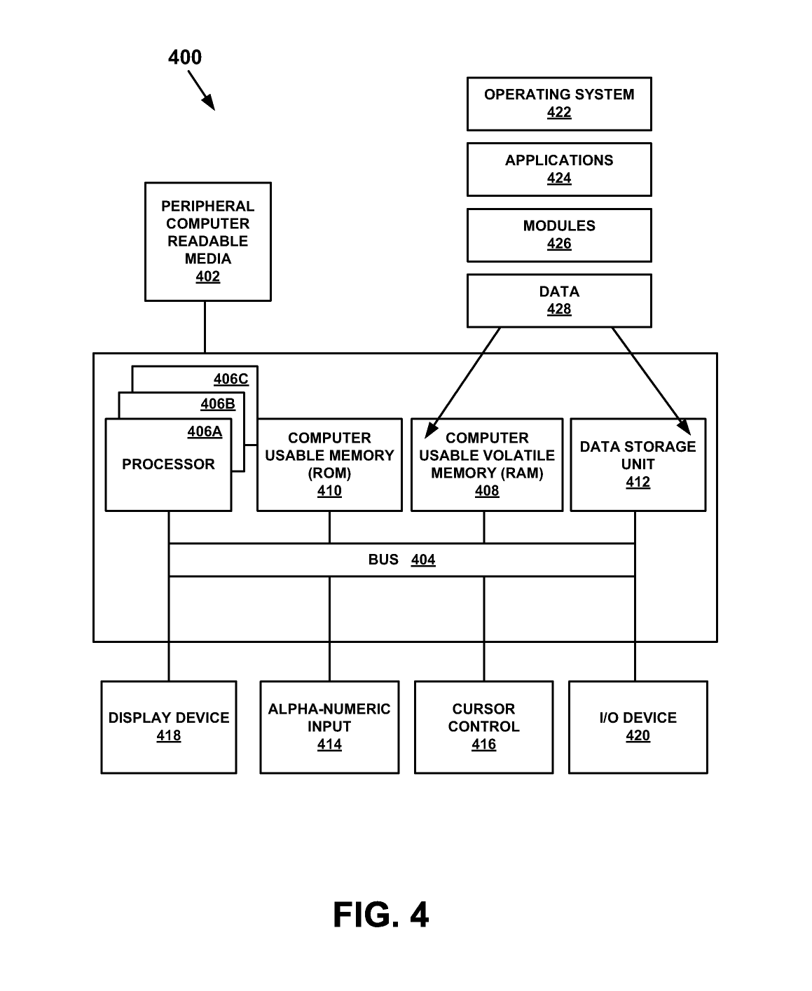

With reference now to FIG. 4, portions of embodiments of the technology for providing a communication composed of computer-readable and computer-executable instructions that reside, for example, in computer-usable media of a computer system. That is, FIG. 4 illustrates one example of a type of computer that can be used to implement embodiments of the present technology.

FIG. 4 illustrates an example computer system 400 used in accordance with embodiments of the present technology. It is appreciated that system 400 of FIG. 4 is an example only and that embodiments of the present technology can operate on or within a number of different computer systems including general purpose networked computer systems, peer-to-peer networked computer systems, embedded computer systems, routers, switches, server devices, user devices, various intermediate devices/artifacts, stand alone computer systems, mobile phones, personal data assistants, and the like. As shown in FIG. 4, computer system 400 of FIG. 4 is well adapted to having peripheral computer readable media 402 such as, for example, a floppy disk, a compact disc, and the like coupled thereto.

System 400 of FIG. 4 includes an address/data bus 404 for communicating information, and a processor 406A coupled to bus 404 for processing information and instructions. As depicted in FIG. 4, system 400 is also well suited to a multi-processor environment in which a plurality of processors 406A, 406B, and 406C are present. Conversely, system 400 is also well suited to having a single processor such as, for example, processor 406A. Processors 406A, 406B, and 406C may be any of various types of microprocessors. System 400 also includes data storage features such as a computer usable volatile memory 408, e.g. random access memory (RAM), coupled to bus 404 for storing information and instructions for processors 406A, 406B, and 406C.

System 400 also includes computer usable non-volatile memory 410, e.g. read only memory (ROM), coupled to bus 404 for storing static information and instructions for processors 406A, 406B, and 406C. Also present in system 400 is a data storage unit 412 (e.g., a magnetic or optical disk and disk drive) coupled to bus 404 for storing information and instructions. System 400 also includes an optional alpha-numeric input device 414 including alphanumeric and function keys coupled to bus 404 for communicating information and command selections to processor 406A or processors 406A, 406B, and 406C. System 400 also includes an optional cursor control device 416 coupled to bus 404 for communicating user input information and command selections to processor 406A or processors 406A, 406B, and 406C. System 400 of the present embodiment also includes an optional display device 418 coupled to bus 404 for displaying information.

Referring still to FIG. 4, optional display device 418 of FIG. 4 may be a liquid crystal device, cathode ray tube, plasma display device or other display device suitable for creating graphic images and alpha-numeric characters recognizable to a user. Optional cursor control device 416 allows the computer user to dynamically signal the movement of a visible symbol (cursor) on a display screen of display device 418. Many implementations of cursor control device 416 are known in the art including a trackball, mouse, touch pad, joystick or special keys on alpha-numeric input device 414 capable of signaling movement of a given direction or manner of displacement. Alternatively, it will be appreciated that a cursor can be directed and/or activated via input from alpha-numeric input device 414 using special keys and key sequence commands.

System 400 is also well suited to having a cursor directed by other means such as, for example, voice commands. System 400 also includes an I/O device 420 for coupling system 400 with external entities. For example, in one embodiment, I/O device 420 is a modem for enabling wired or wireless communications between system 400 and an external network such as, but not limited to, the Internet. System 400 is also well suited for operation in a peer-to-peer computer environment.

Referring still to FIG. 4, various other components are depicted for system 400. Specifically, when present, an operating system 422, applications 424, modules 426, and data 428 are shown as typically residing in one or some combination of computer usable volatile memory 408, e.g. random access memory (RAM), and data storage unit 412. However, it is appreciated that in some embodiments, operating system 422 may be stored in other locations such as on a network or on a flash drive; and that further, operating system 422 may be accessed from a remote location via, for example, a coupling to the internet. In one embodiment, the present technology, for example, is stored as an application 424 or module 426 in memory locations within RAM 408 and memory areas within data storage unit 412. Embodiments of the present technology may be applied to one or more elements of described system 400. For example, a method of modifying user interface 225A of device 115A may be applied to operating system 422, applications 424, modules 426, and/or data 428.

The computing system 400 is only one example of a suitable computing environment and is not intended to suggest any limitation as to the scope of use or functionality of the present technology. Neither should the computing environment 400 be interpreted as having any dependency or requirement relating to any one or combination of components illustrated in the example computing system 400.

Embodiments of the present technology may be described in the general context of computer-executable instructions, such as program modules, being executed by a computer. Generally, program modules include routines, programs, objects, components, data structures, etc., that perform particular tasks or implement particular abstract data types. Embodiments of the present technology may also be practiced in distributed computing environments where tasks are performed by remote processing devices that are linked through a communications network. In a distributed computing environment, program modules may be located in both local and remote computer-storage media including memory-storage devices.

Although the subject matter is described in a language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer implemented method for peer-to-peer multicasting of streaming data in a node in a peer-to-peer computer environment, said method comprising:
receiving a transmission of packets at said node, wherein said packets are data packets pushed from a parent node and comprises data of a sub stream of said streaming data;
creating a buffer map of said node at said node, wherein said buffer map lists said packets that have been received and an available bandwidth of said node;
connecting said node with at least one neighboring node;
exchanging said buffer map of said node with a buffer map of said at least one neighboring node; and
provided a determination is made that at least one packet in said sub stream of said streaming data was not received at said node, pulling said at least one packet from said at least one neighboring.

2. The computer implemented method of claim 1, further comprising:
said node joining a tree disseminating said sub stream of said streaming data by contacting a tracker in said peer-to-peer computer environment to obtain a list of candidates for parent nodes, wherein said parent nodes are connected to said tree;
contacting said candidate parent nodes to discover available resources of said candidate parent nodes; and
selecting a parent node to connect with said node in said tree from said list of candidates, wherein said selecting is based on said available resources of said candidate parent nodes.

3. The computer implemented method of claim 2, further comprising:
determining said node is no longer receiving said transmission of said packets from said parent node; and
connecting said node with said tracker to select a new parent node.

4. The computer implemented method of claim 1, further comprising:
connecting said node to at least one child node; and
relaying said packets pushed from said parent node and said at least one packet pulled from said at least one neighboring node to said at least one child node.

5. The computer implemented method of claim 1, further comprising:
reserving a portion of uplink bandwidth of said node for said at least one neighboring nodes to pull said packets from said node.

6. The computer implemented method of claim 1, further comprising:
connecting said node with a plurality of neighboring node;
determining a round trip time taken to communicate with each of said plurality of neighboring nodes; and
selecting a neighboring node with a smallest round trip time for said pulling said at least one packet.

7. The computer implemented method of claim 1, further comprising:
re-pulling said at least one packet from said at least one neighboring node after a timeout threshold has expired and said at least one packet was not received after said pulling said at least one packet from said at least one neighboring node.

8. The computer implemented method of claim 7 wherein said timeout threshold is equal to a round trip time, wherein said round trip time is a time taken to communicate with said at least one neighboring node.

9. The computer implemented method of claim 1, further comprising:
compressing said buffer map of said node before said exchanging said buffer map of said node with said at least one neighboring node.

10. The computer implemented method of claim 1 wherein said node communicates with and exchanges said buffer map with said at least one neighboring node using a peer-to-peer gossip protocol.

11. The computer implemented method of claim 1, further comprising:
ordering control packets, pushed data packets and pulled data packets in a priority queue at said node;
controlling the out going rate of said control packets, said pushed data packets and said pulled data packets from said node with a token bucket at said node; and
provided that said out going rate exceed a threshold, dropping said pulled data packets from said priority queue in said node.

12. The computer implemented method of claim 1, further comprising:
estimating a delay threshold for a packet to be received at said node from said parent node, wherein said delay threshold is estimated based on how long it takes a previous data packet to be pushed through a tree; and
making a determination to pull a missing packet from said at least one neighboring node based on said delay threshold.

13. A computer-usable storage medium having instructions embodied therein that when executed cause a computer system to perform a method for peer-to-peer multicasting of streaming data in a node in a peer-to-peer computer environment, said method comprising:
receiving a transmission of packets at said node, wherein said packets are data packets pushed from a parent node and comprises data of a sub stream of said streaming data;
creating a buffer map of said node at said node, wherein said buffer map lists said packets that have been received and an available bandwidth of said node;
connecting said node with at least one neighboring node;
exchanging said buffer map of said node with a buffer map of said at least one neighboring node; and
provided a determination is made that at least one packet in said sub stream of said streaming data was not received at said node, pulling said at least one packet from said at least one neighboring.

14. The computer-usable storage medium of claim 13, further comprising:
said node joining a tree disseminating said sub stream of said streaming data by contacting a tracker in said peer-to-peer computer environment to obtain a list of candidates for parent nodes, wherein said parent nodes are connected to said tree;
contacting said candidate parent nodes to discover available resources of said candidate parent nodes; and
selecting a parent node to connect with said node in said tree from said list of candidates, wherein said selecting is based on said available resources of said candidate parent nodes.

15. The computer-usable storage medium of claim 14, further comprising:
determining said node is no longer receiving said transmission of said packets from said parent node; and
connecting said node with said tracker to select a new parent node.

16. The computer-usable storage medium of claim 13, further comprising:
connecting said node to at least one child node; and
relaying said packets pushed from said parent node and said at least one packet pulled from said at least one neighboring node to said at least one child node.

17. The computer-usable storage medium of claim 13, further comprising:
reserving a portion of uplink bandwidth of said node for said at least one neighboring nodes to pull said packets from said node.

18. The computer-usable storage medium of claim 13, further comprising:
connecting said node with a plurality of neighboring node;
determining a round trip time taken to communicate with each of said plurality of neighboring nodes; and
selecting a neighboring node with a smallest round trip time for said pulling said at least one packet.

19. The computer-usable storage medium of claim 13, further comprising:
re-pulling said at least one packet from said at least one neighboring node after a timeout threshold has expired and said at least one packet was not received after said pulling said at least one packet from said at least one neighboring node.

20. The computer-usable storage medium of claim 19, wherein said timeout threshold is equal to a round trip time, wherein said round trip time is a time taken to communicate with said at least one neighboring node.

21. The computer-usable storage medium of claim 13, further comprising:
estimating a time delay for a packet to be received at said node from said parent node; and
making a determination to pull a missing packet from said at least one neighboring node based on said time delay.

22. A system for peer-to-peer multicasting of streaming data in a node in a peer-to-peer computer environment, said system comprising:
a source configured to transmit said streaming data in a plurality of sub streams wherein each sub stream is transmitted over a corresponding tree;
a parent node configured to transmit packets of said sub stream of data in said corresponding tree;
said node configured to receive said packets of said sub stream of data in said corresponding tree from said parent node, re-transmit said packets of said sub stream of data, exchange a buffer map of said node with a buffer map of a neighboring node, and pull a missing data packet from said neighboring node provided that a determination is made that said node is missing a data packet; and
a child node configured to receive said packets of said sub stream of data re-transmitted from said node.

23. The system of claim 22, further comprising:
a tracker configured to provide a list of candidate parent nodes for each of said trees corresponding to said sub streams; and
said node is further configured to select a parent node based on said list of said candidate parents received from said tracker and based on available resources of said candidate parents.

24. The system of claim 22, further comprising:
said neighboring node configured to exchange said buffer map of said neighbor with said buffer map of said node, further configured to allow said node to pull said missing packet from said neighboring node, and pull a data packet from said at node.
